(19) United States
(12) Patent Application Publication
(10) Pub. No.: US 2009/0038459 A1
(43) Pub. Date: Feb. 12, 2009

(54) Lighting System for a Table Saw

(76) Inventors: Wade Burch, Wauwatosa, WI (US); William C. Buck, Clemson, SC (US)

Correspondence Address: MICHAEL, BEST & FRIEDRICH LLP, 100 EAST WISCONSIN AVENUE, SUITE 3300, MILWAUKEE, WI, 53202, US

(21) Appl. No.: 12/171,728

(22) Filed: Jul. 11, 2008

Related U.S. Application Data
(60) Provisional application No. 60/951,333, filed on Jul. 23, 2007.

(51) Int. Cl. B26D 7/00; B26D 1/143; B26D 7/27; B26D 1/14

(52) U.S. Cl. 83/520; 83/477.2; 83/522.11; 83/471.3

(57) ABSTRACT

A lighting system for a table saw is provided. The table saw includes a top surface with an opening through which a blade extends and a measurement scale associated with the top surface and oriented perpendicular to the opening. The top surface of the measurement scale has indicia such that a lighting system backlights the indicia.

This application claims priority to U.S. Provisional Application Ser. No. 60/951,333 filed Jul. 23, 2007, the entire contents of which are incorporated herein by reference.

The present invention relates to a lighting system for use with a table saw and can be useful for illuminating various portions of the saw. In particular, the illuminating system can be used to illuminate one or more of the table scale, a portion of an underside of the table saw, the bevel scale, and the blade height scale.

### SUMMARY

The present invention provides a lighting system for a table saw that provides illumination for one or more of a measurement scale, a bevel adjustment scale and an underside of the top surface of the table saw. In one embodiment, the present invention relates to a table saw that includes a top surface with an opening through which a blade extends. The table saw also includes a measurement scale that is fixed to a portion of the table saw and it has indicia on an upper surface of the measurement scale. The measurement scale may be oriented perpendicular to the opening. The measurement scale may be formed of or may have a portion formed of a material through which light can pass. The table saw also includes a light source capable of directing light in a direction toward an underside of the scale to illuminate the indicia. In one aspect, the light source is capable of alternatively or simultaneously directing light to an underside of the top surface. The light source may be actuated from an actuator separate from the main power switch that actuates the motor to rotate the blade. Alternatively, the light source may be actuated by the main power switch that actuates the motor to rotate the blade. In another aspect, the lighting system may include two separate light sources for each of illuminating the measurement scale—and the underside of the top surface of the table saw.

In another embodiment, the table saw includes a wall extending from the top surface and desirably the underside of the top surface. The wall may include one or both of a bevel adjustment mechanism with a bevel scale located on the wall and a height adjustment mechanism with a height adjustment scale. The lighting system of the present invention will illuminate the controls as well as other controls provided on one or more of the walls. Each of the bevel scale and the height adjustment scale or at least a portion of bevel scale and height adjustment scale is formed of a material through which light can pass and having indicia on an upper surface; a light source capable of directing light in a direction toward an underside of the scale to illuminate the indicia. The light source may be the same or different from the light source for the measurement scale. In this regard, the light source for the bevel scale or height adjustment scale may be actuated from an actuator separate from the measurement scale actuator or the main power switch that actuates the motor to rotate the blade. Alternatively, the light source for the bevel scale or the height adjustment scale may be actuated by the measurement scale actuator or the main power switch that actuates the motor to rotate the blade.

The light source may be any suitable light source such as incandescent, fluorescent, light emitting diode, electroluminescent materials, light emitting capacitor, and other suitable light sources. Where a light emitting capacitor is used a scale can be applied to the surface.

### BRIEF DESCRIPTION OF THE DRAWINGS

FIG. 1 is a perspective view of a representative table saw incorporating the features of the present invention.

FIG. 2 is a side view of the table saw of FIG. 1 with a portion cut away to show a portion of the front wall.

FIG. 3 is a top view of the table saw of FIG. 1.

FIG. 4 is a perspective view of the table saw of FIG. 1 showing a portion of a movable fence associated with the table saw.

FIG. 5 is a partial top view of the table saw of FIG. 1 with the measurement scale illuminated.

FIG. 6 is a view an illuminated measurement scale viewed through a window provided a fence that is attachable to the table saw.

FIG. 7 is a view of a portion of the underside of the top surface of the table saw of FIG. 1 with the portion of the underside being illuminated.

### DETAILED DESCRIPTION

The invention is described with reference to the drawings in which like elements are referred to by like numerals. The relationship and functioning of the various elements of this invention are better understood by the following description. Each aspect so defined may be combined with any other aspect or aspects unless clearly indicated to the contrary. The embodiments described below are by way of example only, and the invention is not limited to the embodiments illustrated in the drawings.

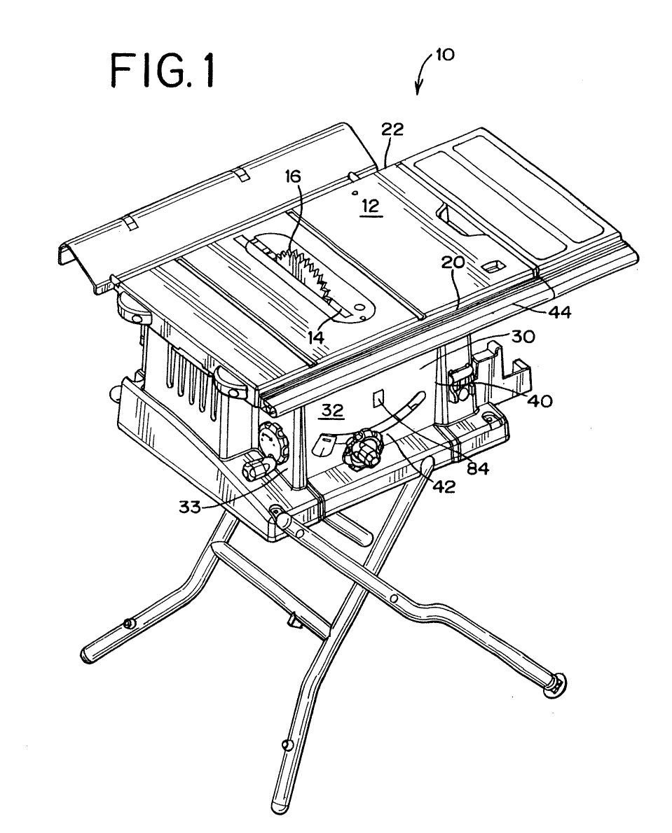

Turning now to FIG. 1, a table saw 10 having a measurement scale 60 that can be illuminated and made in accordance with the principles of the present invention. The table saw 10 can be of any known type such as a stand-alone table saw or a portable table saw. The table saw shown in FIG. 1 is designed to be moved. The table saw 10 includes a top or cutting surface 12. The top or cutting surface 12 includes an opening 14 through which a blade 16 extends. The blade 16 is used to cut material such as wood that is pushed along the top or cutting surface 12.

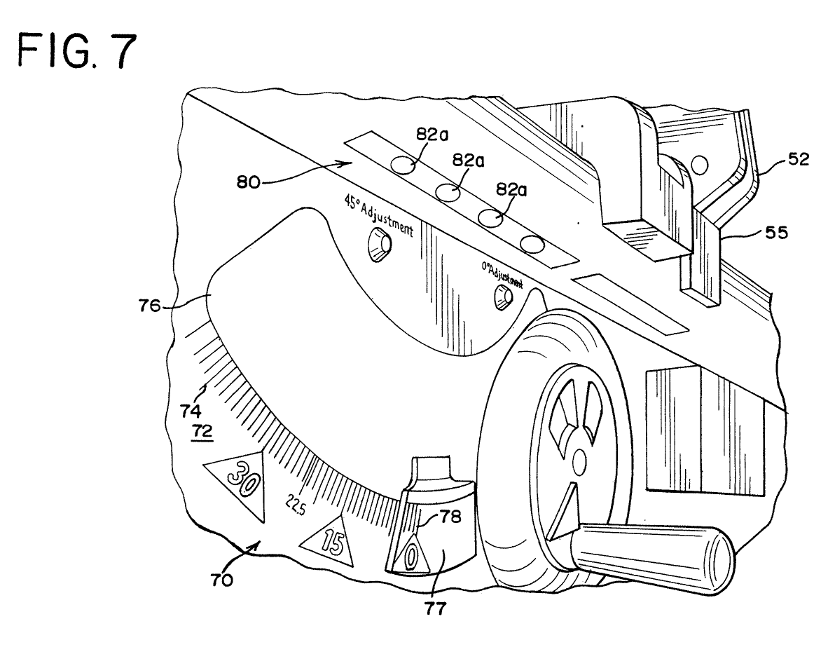

The top or cutting surface 12 includes a front surface 20 and a rear surface 22, each of which is generally perpendicular to the opening 14. It is understood that the designation of front surface 20 and rear surface 22 are merely for purposes of orientation. A wall extends downward from the top surface 12 and in general may include a front wall 30, one or more side walls 33, and a rear wall 36. The front wall 30 may have a first side 32 and a second side 34. Extending outward from the first side 32 may be control mechanisms such as a main power switch 40 to actuate the motor to rotatably drive the blade 16, a bevel control mechanism 42 to control the angle of the blade 16, and/or a height control mechanism to control the height of the blade 16. In this regard, the bevel control mechanism 42 may have an associated bevel scale 70 as shown in FIG. 7. It is also contemplated that one or both of the bevel control mechanism 42 and height control mechanism, as well as their respective bevel scale 70 and height control scale may be provided on either of the side walls 33.

The front surface 20 may have a front rail 44 extending outward from it. The rail 44 can provide a location for the measurement scale 60. In addition, the rail 44 can provide a surface on which a portion of a movable fence 50 can be locked. The rail 44 may have a J-shape or a U-shape to provide a curved surface adjacent the user. In each instance, the rail 44 has a top surface 46 and a bottom surface 48.

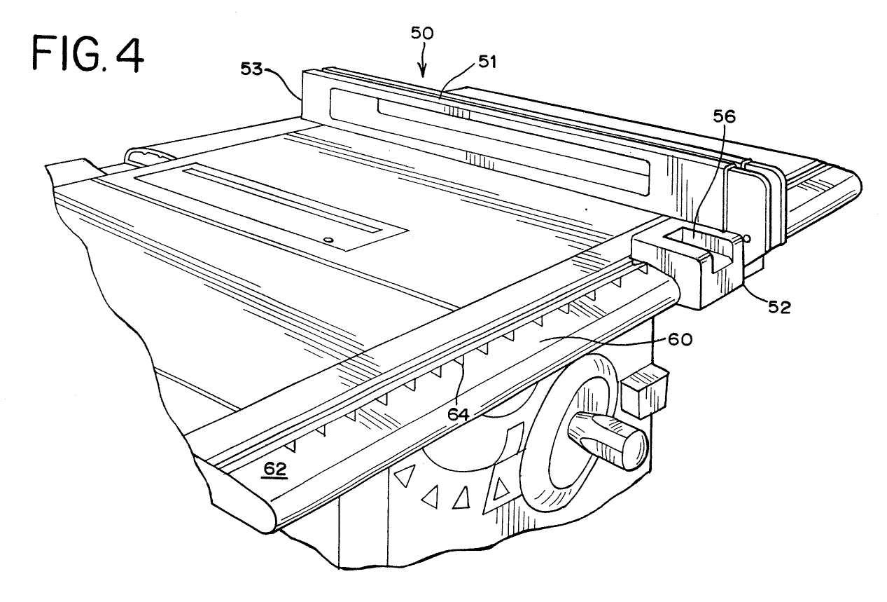

A movable fence 50 partially shown in FIG. 4 may be mounted to the top surface 12. In general, the movable fence 50 is configured to slide along the top cutting surface 12 to position the fence 50 a distance from the blade 16 an amount equal to the width or length of the desired material after cutting. The movable fence 50 has a surface perpendicular to the top surface 12 to assist in cutting the material. Once the fence 50 is properly positioned, the material can slide against the perpendicular surface and across the top or cutting surface 12 to make the desired cut.

The fence 50 can be of any type known in the art and can move on either side of the blade 16. The fence 50 can include a main casing 51, a front clamping portion 52 and a rear clamping portion 53. A locking mechanism (not shown) permits the fence 50 to be in a locked position in which the main casing 51 is aligned generally parallel with the blade 16 or in an unlocked position in which the fence can slide along the top surface. The main casing 51 has a generally rectangular tube form where the two outer surfaces are perpendicular to the top surface 12. The front clamping portion 52, which controls the locking mechanism 54, is attached to the front end of the main casing 51. The front clamping portion 52 includes a handle 55 that pivots between a locked lower portion and a released upper position. The rear clamping portion 53 is attached to the rear end of the main casing 51. The front clamping portion 52 is linked to the rear clamping portion 53 and sequentially clamps against the front 20 and rear 22 surfaces or portions of the top surface 12 when the handle 55 pivots to the locked position.

The measurement scale 60 of the present invention includes a top surface 62 having multiple indicia markings 64 and a bottom surface 66. The measurement scale 60 may be formed as part of the front rail 44 and is generally located on the top surface 46 of the front rail although other locations, such as a side of the front rail, are contemplated. The indicia markings 64 include a zero marking 68 and extend to a last marking. The zero marking 68 indicates when the movable fence 50 is immediately adjacent to or a zero distance from the blade 16. The last marking indicates the distance from the blade 16 when the movable fence 50 is furthest away from the blade 16. The indicia markings 64 may be calibrated to any scale such as the English or metric system and may include each. The indicia 64 are marked and positioned such that they show the exact measurement of the adjacent edge of the circular saw blade 16 to the interface of the fence 50 when aligned with the indicia 64. The indicia 64 are, in fact, positioned to read the distance of the movable fence 50 from a given position on a saw blade 16 width and, to achieve greater accuracy, the fence 50 may be set to a zero position and the blade 16 positioned directly against the movable fence 50. In this manner, the movable fence 50 may be quickly and accurately positioned to provide the desired width of a cut.

The measurement scale 60 or at least the portion of the measurement scale that contains the indicia 64 is desirably formed of a material that allows light to pass through. In this regard, it is not necessary that all light passes through but only that some portion of light passes through so that the indicia 64 is backlit or illuminated. Alternatively, the measurement scale may be formed of a light emitting capacitor such as a flat panel with the indicia 64 printed on the panel. An example of such is a CEELITE™ panel.

The indicia 64 on the measurement scale 60 may be read by a pointer 58 that is located on the movable fence 50. The pointer 58 may be located in a viewing window 56. The viewing window 56 can include a magnifying glass component to assist in the reading of the indicia 64. In addition, calibration markings can be incorporated into the viewing window 56 to aid in the positioning of the pointer at the correct position on the measurement scale 60.

As noted above, a bevel scale 70 may be associated with the bevel control mechanism 42. The bevel scale 70 includes a front surface 72 having multiple indicia markings 74 and a rear surface 76. The multiple indicia markings 74 indicate 0° to 45° tilt of the blade 16. The 0° marking indicates when the blade 16 is vertical or perpendicular to the top surface 12 of the table saw 10. The bevel scale 70 or at least the portion of the bevel scale 70 that contains the indicia 74 is desirably formed of a material that allows light to pass through. In this regard, it is not necessary that all light passes through but only that some portion of light passes through so that the indicia 74 is backlit or illuminated. The indicia 74 on the bevel scale 70 may be read by a pointer 78 that is provided in a viewing window 77 that may include a magnifying glass.

In a similar manner, a height adjustment scale (not shown) may be provided on a wall such as the front wall 30 or a side wall 33. The height adjustment scale may be located near the height adjustment mechanism and may be constructed in a manner similar to the bevel adjustment scale.

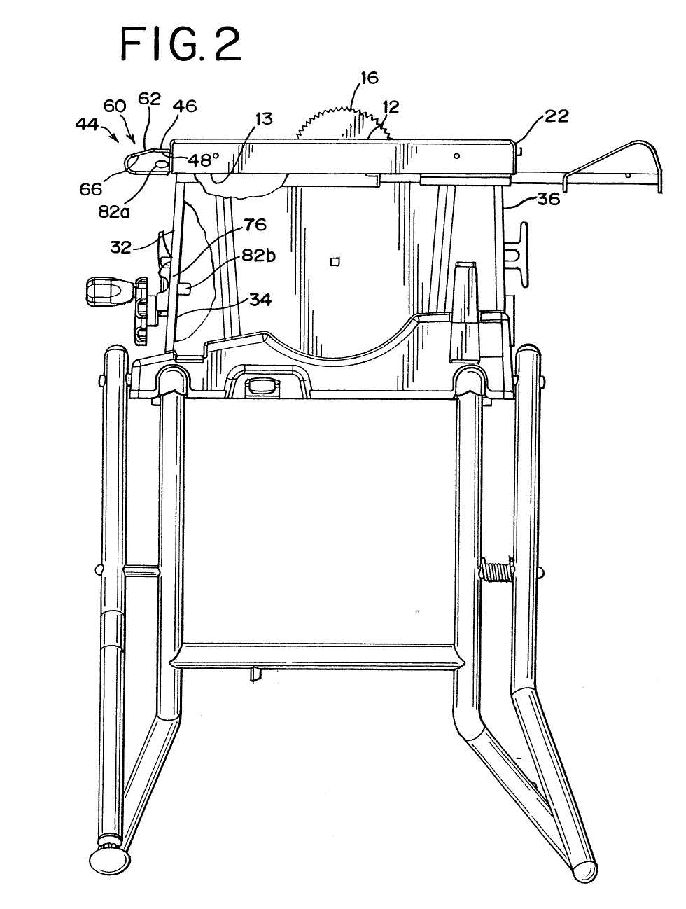

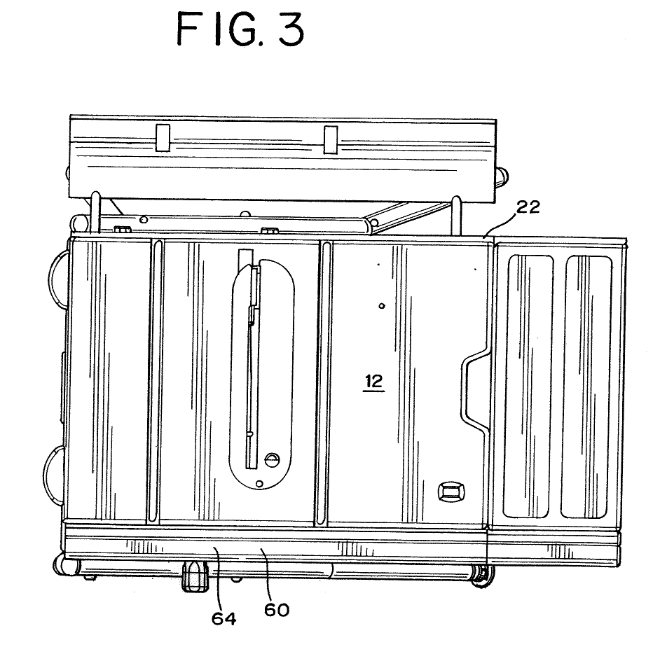

As noted above and referring to FIGS. 2 and 7, a lighting system 80 is provided. In one aspect, the lighting system 80 includes at least one light source 82a, 82b to provide illumination of one or more of the measurement scale 60, the bevel scale 70, and a portion of the underside 13 of the top surface 12, such as adjacent the front wall 30. The portion of the underside 13 of the top surface 12 illuminated may be one or all of the walls where controls for the table saw 10 may be located. For example, the portion of the underside 13 of the top surface 12 that is illuminated may include illumination of a front wall 30 that includes one or more of a height control mechanism, a bevel control mechanism, and a power switch.

In one aspect, the lighting system 80 includes a light source 82a to illuminate the measurement scale 60 and a portion of the underside 13 of the top surface 12 and a separate light source 82b to illuminate the bevel scale 70. In another aspect of the invention, the lighting system 80 provides backlighting of one or more of the measurement scale 60, the bevel scale 80, and the height adjustment scale, and direct lighting of a portion of the underside 13 of the top surface 12. Alternatively, each or all of the measurement scale 60, the bevel scale 80, and the height adjustment sale, may be formed of a light emitting capacitor such as a flat panel with the indicia 64 printed on the panel. An example of such is a CEELITE™ panel. In yet another aspect, the lighting system 80 provides backlighting of the measurement scale 60 simultaneously with direct lighting of a portion of the underside 13 of the top surface 12. Direct illumination of the portion of the underside 13 of the top surface 12 will provide illumination of the height and bevel control mechanisms.

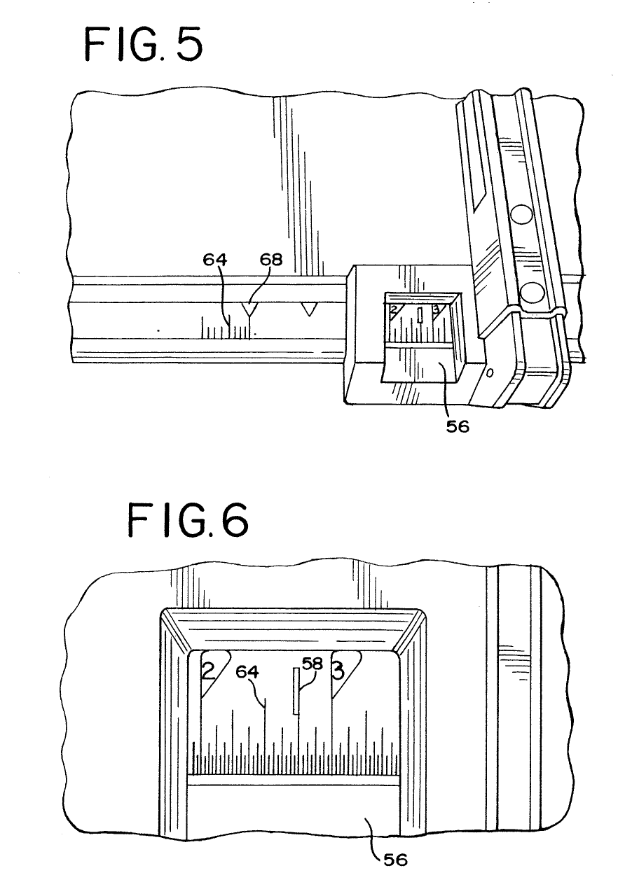

In one embodiment, the lighting system 80 includes at least one light source 82a located such that at least a portion of the light passes from the bottom surface 66 of the measurement scale 60 to the top surface 62 of the measurement scale 60. Accordingly, it will be understood that the light source 82a provides backlighting of the measurement scale 60, as best seen in FIGS. 5 and 6. Advantageously, by providing backlighting of the measurement scale 60 it may be easier for the user to view the indicia 64, particularly within the viewing window 56 of the movable fence 50, as seen in FIG. 6.

In this embodiment, the light source 82a may be located adjacent the bottom surface 48 of the rail 44. The light source 82a may be any suitable light source to provide diffused light in at least two directions so that light will be directed toward the top surface 46 of the rail 44 and away from the top surface 46 of the rail 44. The light source 82a can be one of an incandescent, fluorescent, halogen, LED, etc or the like. The light source 82a may also include one or more than one light sources such as one or more than one light bulb. Those areas of the rail 44 and the table saw 10 that are generally perpendicular to top surface 46 of the rail 44 and upon which the light strikes may be provided or constructed with a light reflective material so that additional light is directed in the desired locations. In this embodiment, as best seen in FIG. 7, the light source 82a provides direct lighting of the underside 13 of the top surface 12 of the table saw 10, particularly adjacent the front wall 30 and more particularly the height adjustment and bevel control mechanisms.

The lighting system 80 may also include a light source 82b adjacent the second side 34 of the front wall 30. The light source 82b is located such that at least a portion of the light passes from the rear surface 76 toward the front surface 72 of the bevel scale 70 to provide backlighting of the bevel scale 70. The light source 82b may be any suitable light source to provide diffused light at least in one direction so that light will be directed toward the front surface of the bevel scale. The light source 82b can be one of an incandescent, fluorescent, halogen, LED, etc or the like. The light source 82b may also include one or more than one light sources such as one or more than one light bulb.

The lighting system 80 may be actuated from the main power switch 40 that controls the motor driving the blade 16. Alternatively, the lighting system may be actuated by a switch or actuator 84 separate from the main power switch 40. In this regard, there may be one or more switches or actuators to control each of the light sources of the lighting system. When the lighting system 80 includes an actuator 84 separate from the main power switch 40, the lighting system actuator 84 may be provided at a convenient location on the front wall 30.

The foregoing detailed description has described only a few of the many forms that this invention can take. For this reason, this detailed description is intended by way of illustration, and not by way of limitation. It is only the following claims, including all equivalents that are intended to define the scope of this invention.

1. A table saw comprising:
a. a top surface with an opening through which a blade extends;
b. a measurement scale associated with the top surface and oriented perpendicular to the opening, the scale having a top surface with indicia; and,
c. a lighting system including a light source to backlight the indicia.

2. A table saw comprising:
a. a top surface with a front surface and an opposite rear surface, the top surface including an opening perpendicular to the front surface and through which a blade extends;
b. a measurement scale along the front surface and having a top surface with indicia; and,
c. a lighting system including a light source to backlight the indicia.

3. The table saw of claim 2 wherein the rail includes a top surface and a bottom surface.

4. The table saw of claim 3 wherein the measurement scale is located on the top surface of the rail.

5. The table saw of claim 2 further comprising a wall extending from the top surface and having at least one of a bevel control mechanism and a blade height mechanism.

6. The table saw of claim 5 wherein the lighting system provides direct lighting of at least one of the bevel control mechanism and the blade height mechanism.

7. The table saw of claim 5 wherein the lighting system provides simultaneous direct lighting of the bevel control mechanism and the blade height mechanism.

8. The table saw of claim 5 comprising a bevel control mechanism and a bevel scale associated with the bevel control mechanism.

9. The table saw of claim 8 wherein the lighting system provides backlighting of the bevel scale.
